(19) United States
(12) Patent Application Publication
(10) Pub. No.: US 2022/0187498 A1
(43) Pub. Date: Jun. 16, 2022

(54) DATA PROCESSING FOR INTERSECTION-MOUNTED WEATHER STATIONS

(71) Applicant: The Get Go Inc., dba GGI Road & Traffic, Richmond Hill (CA)

(72) Inventors: Scott GODFREY, Richmond Hill (CA); Lisa GODFREY, Richmond Hill (CA)

(21) Appl. No.: 17/200,363

(22) Filed: Mar. 12, 2021

(30) Foreign Application Priority Data
Dec. 16, 2020 (CA) 3102731

(51) Int. Cl. G01W 1/10

(52) U.S. Cl. CPC G01W 1/10; G01W 2001/006

(57) ABSTRACT

A weather station system is provided, comprising: a weather station having at least one sensor disposed at an intersection with a traffic cabinet; an interface card adapted for insertion in a detection rack of a traffic cabinet. The card has embedded firmware to receive data from the at least one sensor of the weather station and communicate the data to at least one remote computing device for processing with data of other weather stations. A weather data processing system and a method of retrieving localized weather data are also provided.

### FIELD OF THE INVENTION

A method and system is provided for data processing for intersection-mounted weather stations. Related weather station systems and weather station processing systems are also provided.

### BACKGROUND

Municipalities gather weather related data from weather stations dispersed over a large area, which is collected centrally in order to provide reporting and forecasting. The dedicated infrastructure for such stations, however, is expensive, in some cases running in excess of $100,000 per station. The infrastructure for such existing weather stations typically includes dedicated towers or poles, which support any station sensors and cameras, as well as a dedicated hardened communication box, which includes separate power source and communication hardware. In addition, the location of the station must be able to support the space requirements of such infrastructure. This may be difficult in densely packed urban areas. In many typical deployments, there are only a few such stations per municipality, and in some deployments, the locations are hundreds of miles apart.

Municipalities also currently invest in dedicated traffic infrastructure, although this is separate from weather stations. Typically, traffic infrastructure is much more densely deployed. Each controlled intersection typically has its own traffic cabinet with local sensors and communication equipment.

More localized weather data collection would be desirable. More weather stations within a municipality, dispersed at greater density, would result in richer data quality as well as quantity. Localized data would also facilitate localized alerts, such as alerts directly communicated to automobiles in that area, or to mobile devices in that area. Localized data would also facilitate municipal decision-making with regard to local conditions, such as decisions regarding snow removal and road salt. It would therefore be desirable to simplify the infrastructure and space requirements for such stations in order to promote more widespread adoption and denser networks of weather stations.

### SUMMARY OF THE INVENTION

Broadly speaking, the present invention aims to address the need for more widespread and denser networks of weather stations by piggy-backing on existing hardware at intersection-level. Through a card that engages power and communications infrastructure of existing traffic cabinets, the system would allow for easy deployment of weather stations at traffic intersections for wide scale deployment. This would avoid the need for a separate weather station box on a pole requiring its own wired power, etc., saving installation time, while reducing material cost and complexity.

Further, deployment is enhanced as the interface is card-based and can be installed within the traffic cabinet and within the detection rack making it very quick, inexpensive and without disruption to the traffic cabinet operation.

According to a first aspect of the invention, a weather station system is provided comprising: a weather station having at least one sensor disposed at an intersection with a traffic cabinet; and an interface card adapted for insertion in a detection rack of the traffic cabinet. The card has embedded firmware to receive data from the at least one sensor of the weather station and communicate the data to at least one remote computing device for processing with data of other weather stations.

Preferably, the weather data includes at least one of: road temperature, subsurface temperature, freezing temperature, water film height, friction, saline concentration, road condition, precipitation type, visibility, wind speed, wind direction, air temperature, dewpoint, relative humidity, and relative air pressure.

The at least one sensor may include a weather sensor mountable at road level (or below road level), or above road level. In preferred embodiments, the at least one sensor includes a camera.

Preferably, the interface card includes programmed functionality to communicate with the weather station and the remote computing device using a protocol selected from Ethernet, USB, WiFi and Cellular.

Preferably, the signaling from the weather station uses RS-485.

Preferably, the card is adapted for insertion in the detection rack by having a form factor approximating the form factor of a traffic detection card.

According to a second aspect of the invention, a weather data processing system is provided that includes: a plurality of weather stations each having at least one sensor; a plurality of interface cards, each integrated with a traffic cabinet co-located at intersection level with a respective one of the plurality of weather stations, each interface card having embedded firmware to receive data from the respective weather station; and a centralized hub for receiving data from the plurality of interface cards and processing the data to provide localized weather reporting and forecasting.

Preferably, at least one of the weather stations is mounted on a power pole, utility pole, or traffic signal pole preexisting at the intersection.

In some embodiments, wherein the weather data is preprocessed before transmitting the data to the centralized hub.

Preferably, the weather data is processed before being transmitted by the centralized hub for reporting and forecasting.

In some embodiments, the localized weather reporting and forecasting is directed to a user device (e.g. a mobile or onboard device).

In some embodiments, the localized weather reporting and forecasting is directed to a subscriber near the intersection. The device/user may be detected to be near the intersection by location detection of the user's device or by other proximity detection (e.g. WiFi or RFID). In some embodiments, data or alerts may be directly supplied to Connected Vehicles or Autonomous Vehicles (CAVs).

In some embodiments, an alert related to the localized weather reporting and forecasting is directed to a road display and/or signaling system such as flashing warning beacons.

According to a third aspect of the invention, a method for retrieving localized weather data is provided, which includes:

retrieving from a weather station having at least one sensor disposed at an intersection with a traffic cabinet a string of weather related data;

through an interface card adapted for insertion in a detection rack of the traffic cabinet, the card having embedded firmware to receive data from the at least one sensor of the weather station, communicating the data to at least one remote computing device for processing with data of other weather stations.

In a preferred embodiment of the systems and methods, the at least one sensor uses power and/or communications connections or wiring preexisting in the traffic cabinet. For instance, preexisting inductive loop connections and/or wiring (that are no longer needed) can be repurposed for power or data for the at least one weather sensor and/or power, data and video signals for any connected camera (treated herein as a “sensor”). The weather station may include a single sensor, such as a camera, or may include multiple sensors. The sensors may have distinct or redundant or overlapping roles.

### BRIEF DESCRIPTION OF THE FIGURES

FIGS. 1A and 1B are intersection views showing pole-mounted weather station and dedicated weather station cabinet.

FIG. 2 is a front perspective view of a sample traffic cabinet.

FIG. 3 is an interior view of a sample traffic cabinet showing rack and card slots.

FIG. 4A is a perspective view of a sample card of the present invention.

FIG. 4B is a detail view of front panel components of the sample card of FIG. 4A.

FIG. 4C is a side view showing sample pinout and handle.

FIG. 5 is a block diagram of card components.

FIG. 6 is a network diagram of a network according to an embodiment of the present invention.

FIG. 7 is a sample chart of some typical types of weather data.

### DETAILED DESCRIPTION

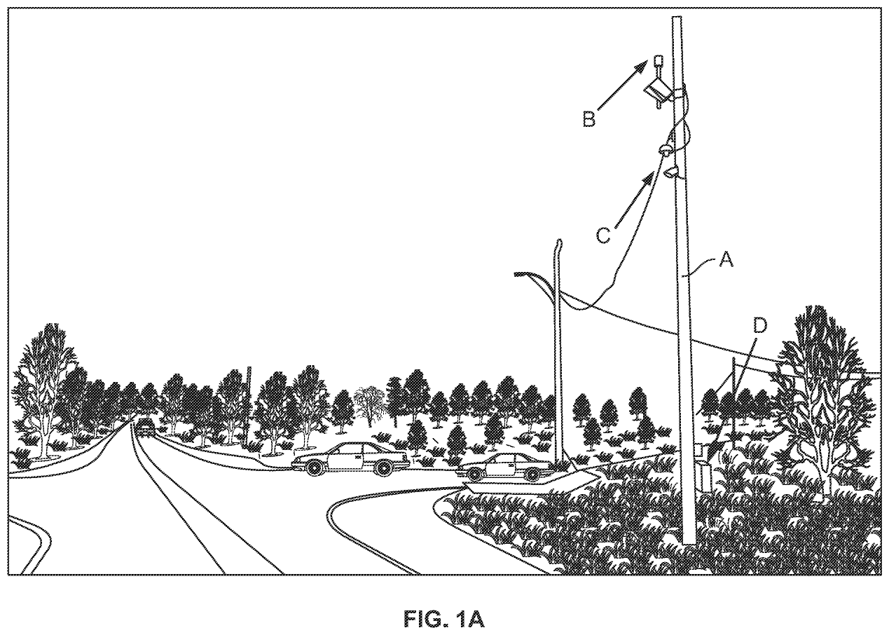

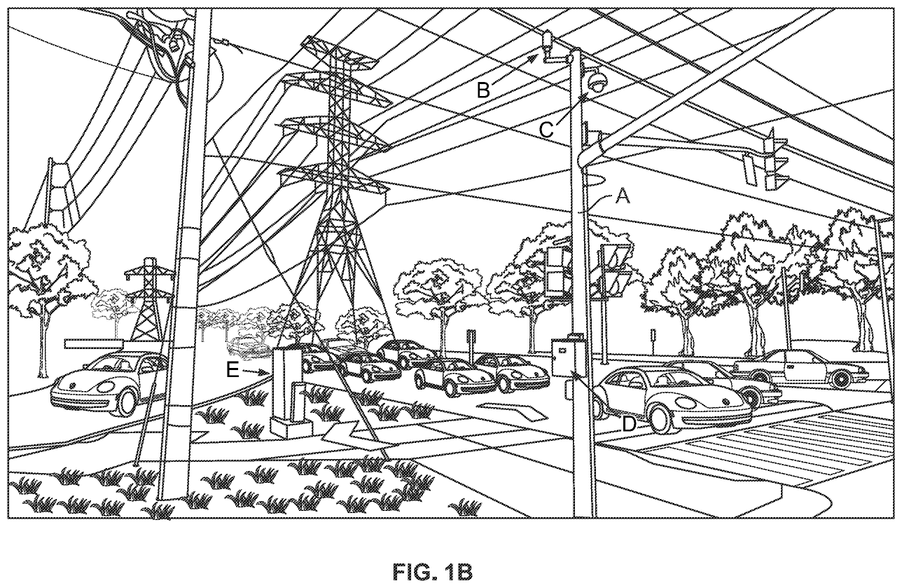

FIG. 1A is a prior art intersection view showing a weather station at an intersection having a dedicated pole A. On the pole are mounted at least one weather station sensor B, one or more cameras C, and a weather station cabinet D. The weather station functions by receiving data through sensors B and cameras C, and transmitting that data from communications hardware in the cabinet D to a remote data hub (not shown).

The weather station cabinet D includes dedicated power supply and communications hardware.

FIG. 1B is another prior art intersection view showing a typical weather station with pole-mounted sensor B, camera C, and cabinet D. In current embodiments, this is separate and apart from traffic cabinet E. The traffic cabinet E contains power supply and communications hardware for traffic detection either from cameras or road-mounted detection sensors (e.g. inductance loop sensors) (not shown).

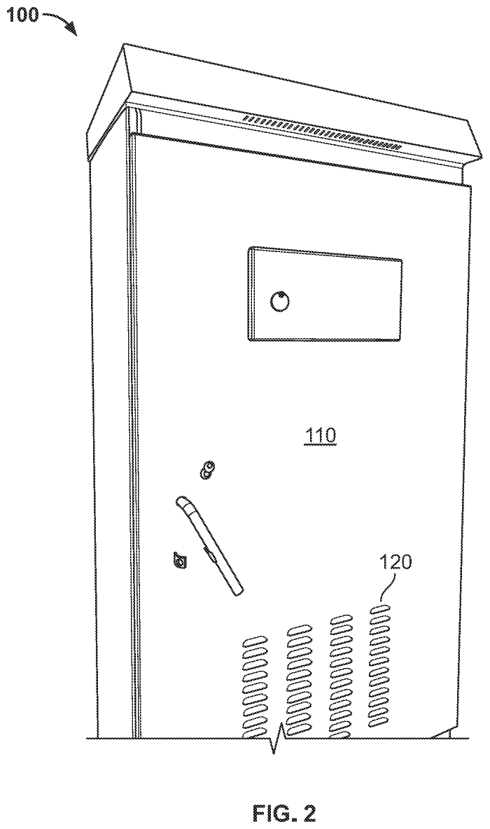

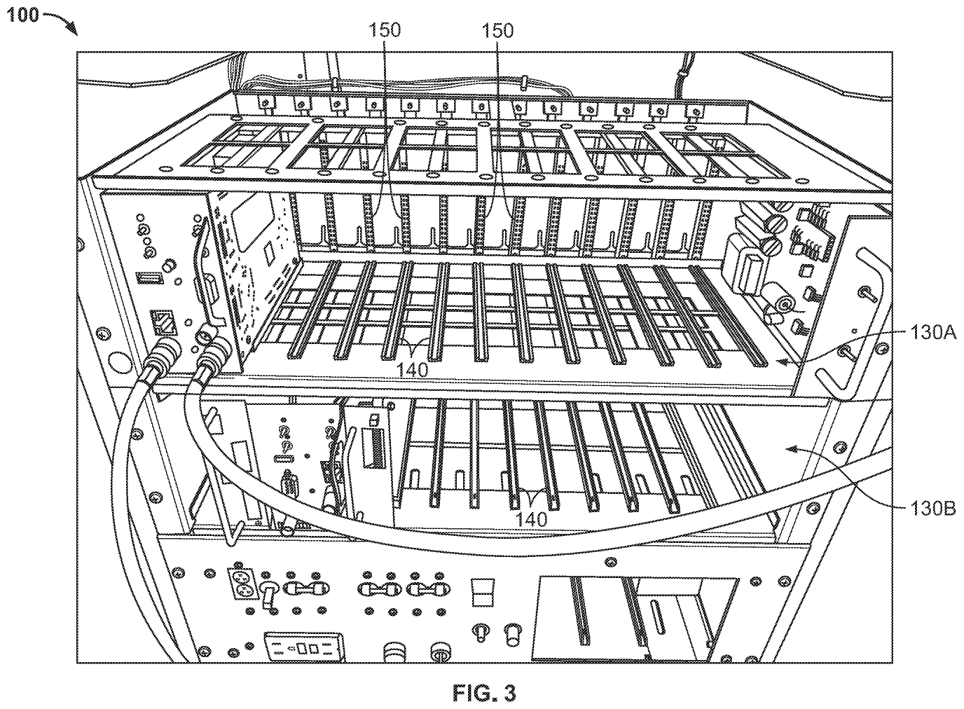

FIG. 2 is a front perspective view of a sample traffic cabinet 100, with FIG. 3 showing an interior view of the sample traffic cabinet 100 showing sample racks 130A, 130B and card slots 140. A traffic cabinet 100 is a hardened box containing communications hardware. Such a box typically has a heated and ventilated 120 construction. Its internal components are accessible through a lockable exterior door 110. Traffic cabinets are disposed at each signaled traffic intersection (one box per intersection). There are various standards related to traffic cabinets, which include NEMA 4. The traffic cabinets are typically at ground level, making them easy to access by maintenance technicians.

In a typical arrangement, as shown in FIG. 3, a traffic cabinet 100 has one or more internal racks 130A, 130B that receive specially designed electronic cards in slots 140 and connectors 150. Cards for traffic detection have been used in these racks in the past. In basic terms, when a car pulls up over an embedded wire in the road, this changes the inductance level of that wire. The card senses this change and sends an electrical signal to the traffic controller to change the traffic light to green. Other types of interface cards use other detection methods (e.g. camera sensors) to detect vehicles at the intersection in order to send a signal to the traffic controller to change the light to green.

However, for various reasons, the internal racks of most intersection traffic cabinets are not in full utilization. There are empty slots available. These slots are available to receive additional cards, which can take advantage of the traffic cabinet's preexisting power and communications architecture. Where there is no space in the detection rack (or if preferred by the user), cards may also be plugged into an auxiliary rack that sits on a shelf of the traffic cabinet. For instance, if there are few or no slots available in the existing detection rack (i.e. it is full of detection cards), a small auxiliary rack may be used.

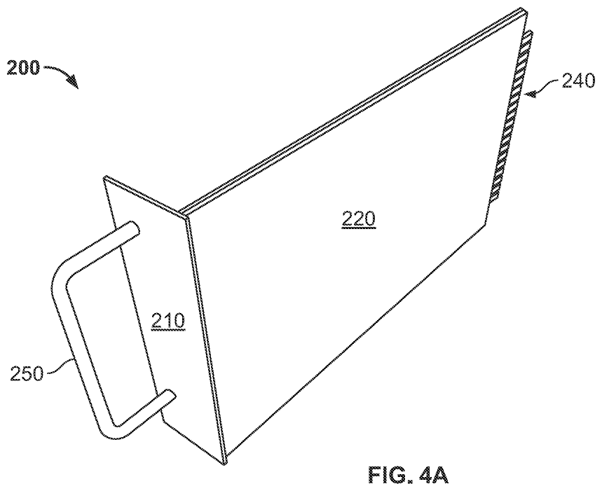

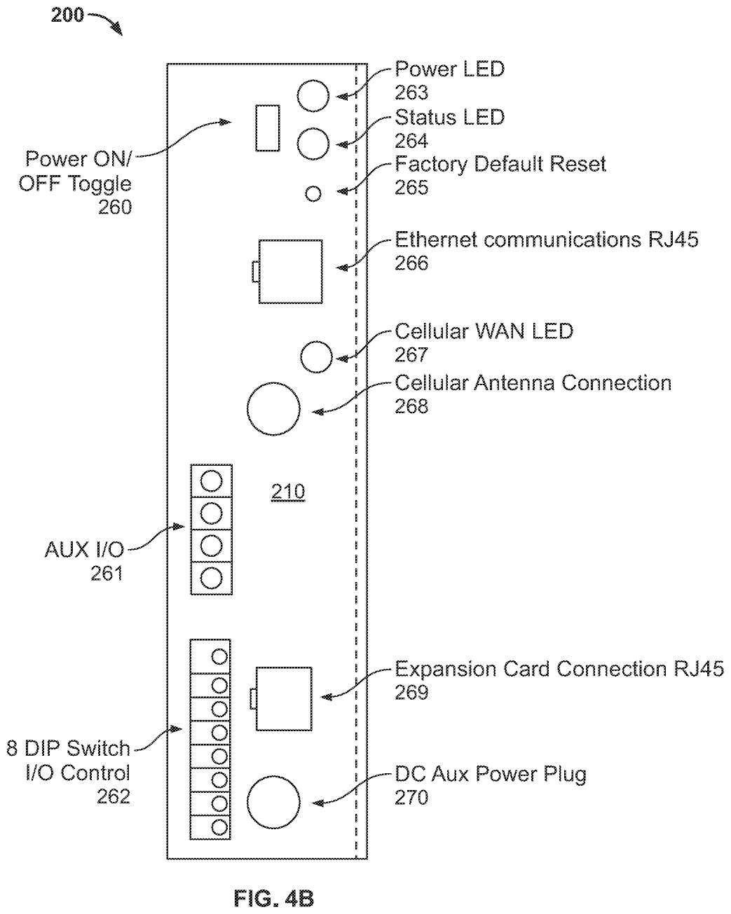

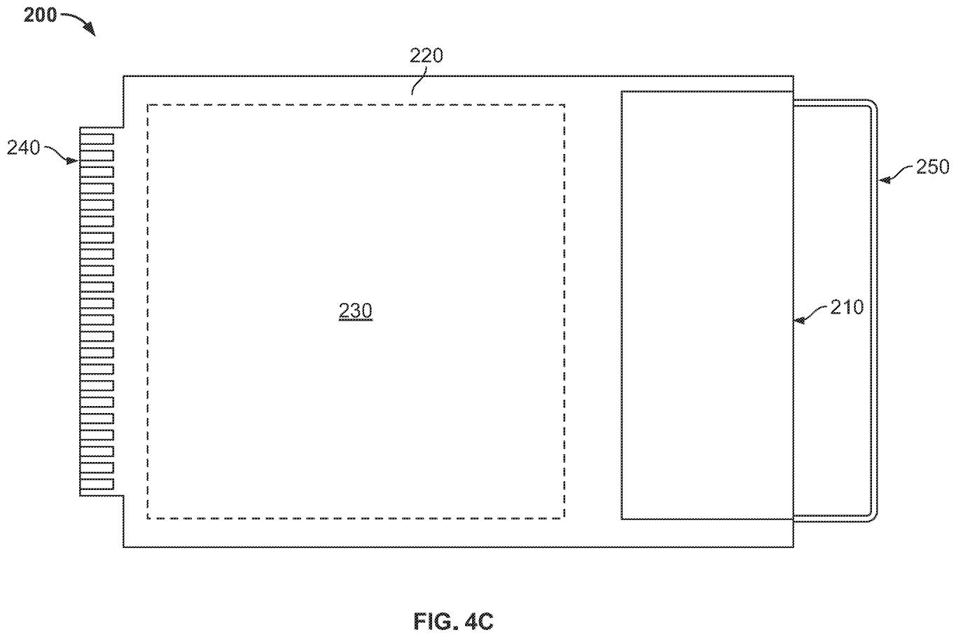

A sample card 200 according to an embodiment of the present invention is shown in FIG. 4A. The card 200 preferably has an overall construction as shown in FIG. 4A, having a front panel 210, side panel 220, and edge connectors 240. A handle 250 may be provided opposite the pin end of the card for maneuvering the insertion or removal of the card. The card plugs into an available slot of one of the detection racks to get power from the rack and for convenience. However, instead of receiving traffic detection sensor data, the card receives data from a weather station that may also be mounted at the intersection. The card provides a hardware platform with embedded firmware to transceive data with sensors in the weather station, which data is then transmitted up/down to a third-party cloud or centralized systems. The weather station need not have its own designed cabinet, but can make use of the existing infrastructure of the intersection-level traffic cabinets, which have extra card capacity in any event. The traffic cabinet is used as an outstation interface in lieu of a dedicated weather station communications box.

Plugging the card 200 in the rack 130A, 130B, unused traffic cabinet wiring is repurposed (as those wires were used for inductive loops that are no longer used) to be the electrical connection to weather station sensor(s).

These conductors, mainly, run from the inductive loop terminal blocks on the detector interface panel to the detection rack. There is a total of 4 conductors available when the card is inserted in a 2-channel detection rack slot and there is a total of 8 conductors available when the card is inserted into a 4-channel detection rack slot. These conductors will be used for power and data for the weather sensors and/or for power, data and video signals for any connected camera. Therefore, the weather sensors or camera can be easily connected inside the traffic cabinet as no terminals need to be added, etc. The sensors and cameras can simply be hooked up to preexisting loop terminal blocks, saving time, money and space.

Turning to FIG. 4B, a detail view is provided of certain possible components on the front panel 210 of the sample card 200 of FIG. 4A. The front panel 210 includes Power LED 263 (to indicate powered connection), Status LED 264 (to indicate error-free status), a Power ON/OFF toggle 260 (to switch between power on and off). A button is provided for factory default reset 265. An Ethernet RJ45 connection 266 is provided for Ethernet communications. An expansion card connection 269 may also be provided. To enable cellular connection, a cellular antenna connection 268 may be provided with dedicated cellular WAN LED 267. Additional auxiliary input-output 261 and DIP switches 262 may be provided.

As shown in FIG. 4C, in a side view, the panel 220 of card 200 will have appropriate pinout edge connector arrangement for engagement with the slots of the traffic cabinet rack. The form factor is specifically chosen to correspond to the form factor of the cards used in traffic cabinets. For instance, such cards may conform to the standard for NEMA TS 2 Traffic Controller Assemblies with NTCIP Requirements Version 02.06 (a standard currently used for Inductive Loop Detector Units). The side panel 220 includes a main board outlined at 230. The main board 230 is preferably located above the bottom edge of the card 200 to allow clearance for the card to sit in one of the slots 140. The main board may be a single-board computer (SBC).

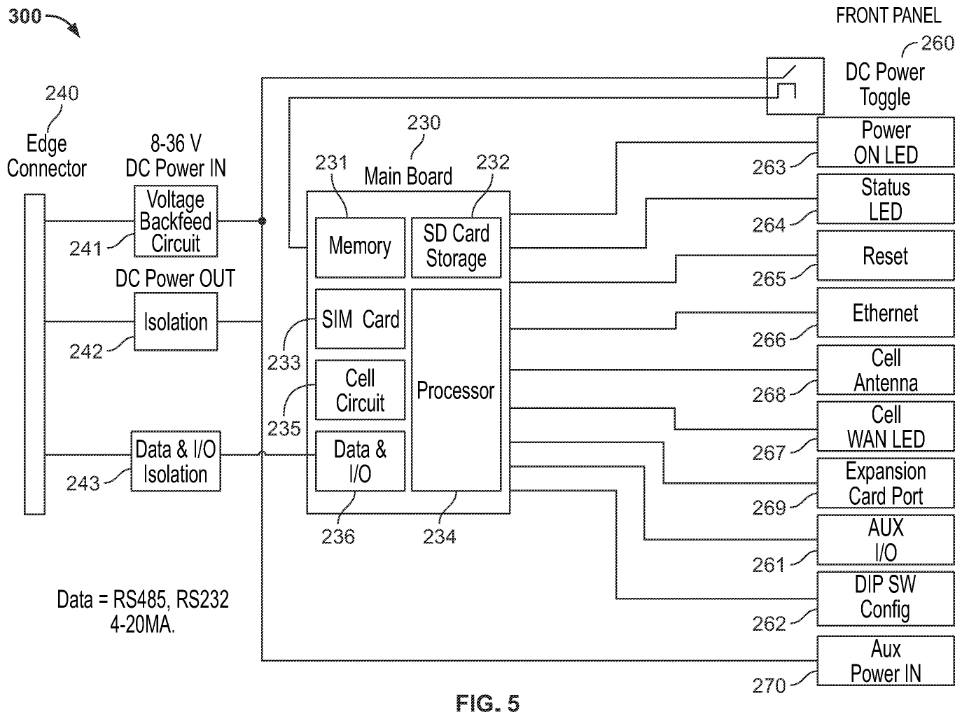

The electronic components, controls and indicators are illustrated in block form 300 in FIG. 5. The overall card 200 includes two boards: a main board and a daughter board with a front panel 210 with handle 250.

The daughter board has attached the front panel with handle, status LEDs, switches and various connectors on it. The daughter card also has an edge connection 240 on the rear for inserting into the detection rack of the traffic cabinet. In addition, the daughter card is equipped with power, video and data isolation circuits 241, 242, 243 to protect the card, the weather sensors and/or camera as well as the traffic cabinet hardware.

Through the main board of card 200 and its onboard processor 234, the card is able to collect weather station data and transmit that data. The main processing board 230 sits on the daughter board on “stand-offs” and is connected to the daughter board, for power and data via a combination of pins, ribbon cables and edge connectors. On this main board resides the active memory and storage memory 231, cellular SIM card slot 233, processor 234, SD Card storage 232 and cell modem 235. The operating system, the weather station and camera applications, data processing and the weather station transceiver programming runs on the main board.

The daughter card provides the following on the front panel 210:

1. Toggle Switch 260 when in the “On” position provides DC power to the entire card. In the “Off” position, DC power to card is inhibited.

2. Power LED 263 that is illuminated when DC power is applied to the card and is not illuminated when the DC power is off.

3. Fault Status LED 264 that indicates operational state of the card. For instance, the LED will be illuminated when there is a fault, flashing when “booting” up and will not be illuminated when the card is in a normal status.

4. Reset Push Button 265 that will reset the network settings to factory programmed network settings default and restart the card.

5. RJ45 Ethernet Connector 266 to facilitate connection to an external communication device like a network router or cellular modem. Communication of data and/or video is provided on this connector and will also serve as the computer connection locally for card programming.

6. Wide Area Network (WAN) Status LED 267 will be illuminated when a WAN connection to the cellular network is established.

7. SMA Cellular Antenna Connector 268 to facilitate connection to a cellular antenna.

8. RJ45 Ethernet Connector 269 to facilitate connection to an expansion card to all for additional weather sensors and or cameras to be processed by this card.

9. A DIN plug connector 270 to allow for the addition of auxiliary DC power in the event that power from the detector rack is not sufficient to power the weather sensor and or camera, this connector can be connected to an external power supply to provide adequate power in this case.

10. An Auxiliary Terminal 261 block that can be used to provide the power and data connection to weather sensors and or camera if the card cannot be used with existing traffic cabinet detector rack wiring.

11. A bank of DIP switches 262 that can be programmed to enable or disable programming features of the card so that a technician does not need to use a computer to turn on or turn off commonly used features.

In operation at the local level, weather sensor data is received from locally mounted weather sensors and cameras (not shown), which may be mounted on existing poles, such as traffic signals, power or utility poles, through one of the network protocols available. For example, the raw weather sensor data may be received through RS-485 signaling from the weather station sensors. This data may be preprocessed or may be transmitted directly to a centralized hub. Further aggregation and processing may be done at the centralized hub prior to retransmission for forecasting and reporting on current weather status.

Various OS, firmware and browser configurations are possible. Linux is one presently preferred operating system platform.

There may be several communication formats available on the card for expanded development or compatibility adaptation including USB, WiFi, Cellular, Ethernet to make it suitable for other applications, including “Internet of Things” (IoT) applications. Preferably, an external modem is used as most traffic cabinets have in-built communications. Alternatively, an internal modem board may be provided with SIM card slot (e.g. through a separate plugin circuit). This may be preferable if billing for weather data collection is different from billing for traffic data.

Typical data received from the weather station at the intersection will include precipitation, air pressure, temperature, wind speed and direction, humidity. These may be measured, sensed or detected above ground through appropriate sensors and/or cameras. Other road-level data may be measured, sensed or detected through road-mounted sensors.

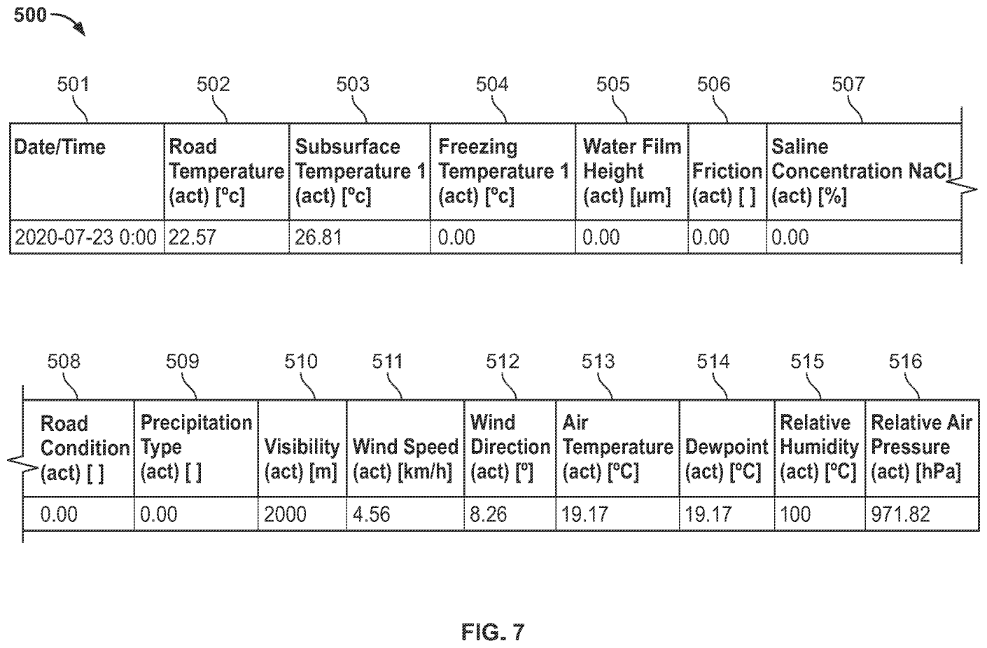

A sample chart 500 of some typical types of weather data is shown in FIG. 7. The present system preferably interfaces with a variety of sensors including atmospheric, hydrology, road sensors and cameras etc. As noted, some typical data collected may include:

Road temperature 502

Subsurface temperature 503

Freezing temperature 504

Water film height 505

Friction 506

Saline concentration 507

Road condition 508

Precipitation type 509

Visibility 510

Wind speed 511

Wind direction 512

Air temperature 513

Dewpoint 514

Relative humidity 515

Relative air pressure 516

This is not an exhaustive list and other data points may include ones related, for example, to air pollution or emissions.

It may also be possible or desirable to combine and transmit traffic data together with weather data. Further, there may be applications where user-supplied data is provided locally which is combined or supplemented with transmitted weather data (e.g. local user-generated photographs showing conditions) or local user-based reports of conditions (e.g. snow accumulation, power outage conditions, etc.) User-generated data may be harvested from devices or vehicles at intersections or may be retrieved from other local network sources or databases. Further, weather data may be transmitted directly to mobile devices, such as in response to detected location of that device in proximity to the interface (e.g. through device GPS). Alternatively, weather data or related alerts could be displayed at local fixed or temporary displays (e.g. highway- or road-construction-type displays or warning beacons could show road condition or weather condition alerts) or in device displays (e.g. in-vehicle displays, including displays within municipal vehicles such as snow plows or salting trucks). In some embodiments, data or alerts may be directly supplied to Connected Vehicles or Autonomous Vehicles (CAVs) and used in decision-making or control systems therein. For instance, localized data or alerts may be supplied when the vehicle is detected to be in the vicinity of a specific weather station.

Of note, data collected from the one or more weather station sensors will preferably be time and date stamped 501 for an accurate log. Collection may be continuous or intermittent (e.g. at predetermined intervals). Also, collected data may be transmitted as received or may be cached over a period of time before being transmitted to a central hub. Collection may be increased at certain times of day or in certain seasons or under certain conditions (e.g. storms). Weather data collection may also be increased responsive to other indicators at the intersection (e.g. increased traffic or a detected accident).

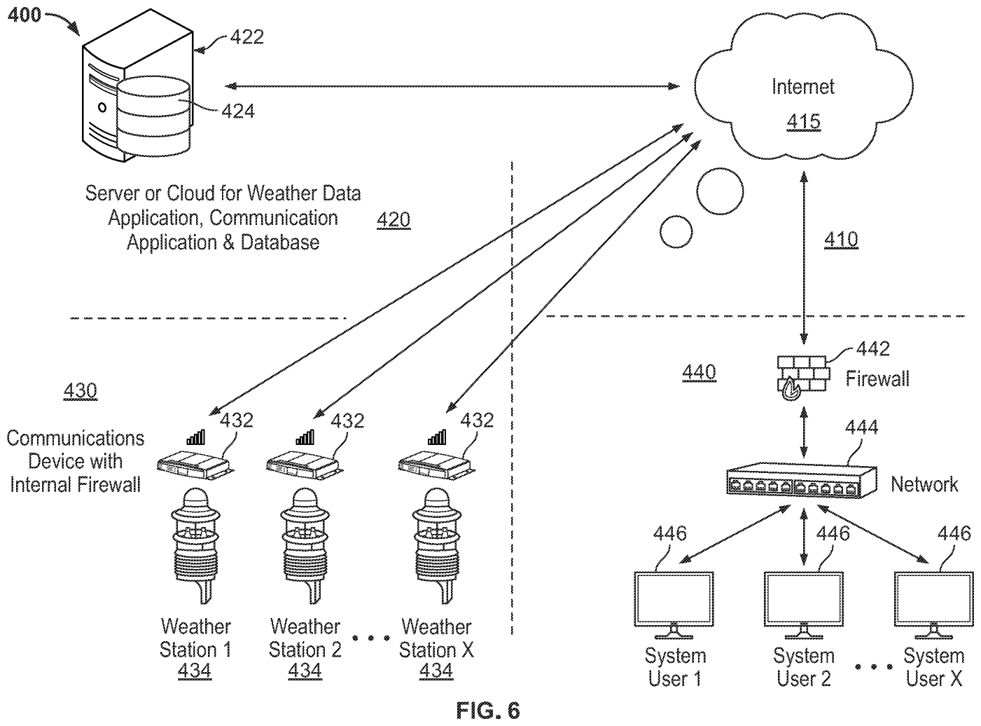

FIG. 6 illustrates a sample network arrangement. Broadly speaking, the network configuration has four quadrants: field equipment 430, office or cloud equipment (central hub) 420, customer/subscriber equipment 440, and Internet services 410 to enable communications among the other quadrants. Weather stations 1, 2, . . . X 434 communicate weather data to their respective intersection-based communications devices 432 (in the traffic cabinets). These in turn communicate via internet with (1) processing hub 422, 424 including server or cloud for weather data applications, communication and database storage; and (2) customer office equipment. A “customer” in this case is any entity contracted to receive weather data, such as for planning, forecasting, reporting or decision-making purposes. Such data may be directed to a maintenance decision support system (MDSS), for example, to make automated recommendations on salt solutions, application rates, etc.

The customer will receive processed data according to their requirements, for example, on their respective client system user 1, 2, . . . X 446 via, typically, a firewall 442 and network server 444. The system of the present invention may include all or only specific portions of this overall architecture.

Although municipal or other jurisdiction road-based applications have been described and illustrated herein, it will be appreciated that other applications would also benefit from the systems and methods presently outlined, including airport runway applications among others.

In addition to computing device aspects, a person of ordinary skill will understand that computer program product aspects are disclosed, where instructions are stored in a non-transitory storage device (e.g. a memory, CD-ROM, DVD-ROM, disc, etc.) to configure a computing device to perform any of the method steps or aspects described herein.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “include” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

The foregoing description illustrates only certain preferred embodiments of the invention. The invention is not limited to the foregoing examples. All of the features disclosed herein (including any accompanying claims, abstract and drawings), and/or all of the steps of any method or process so disclosed, may be combined in any combination, except combinations where at least some of the features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A weather station system, comprising:
a weather station having at least one sensor disposed at an intersection with a traffic cabinet;
an interface card adapted for insertion in a detection rack of the traffic cabinet, the card having embedded firmware to receive data from the at least one sensor of the weather station and communicate the data to at least one remote computing device for processing with data of other weather stations.

2. The system of claim 1, wherein the weather data includes at least one of: road temperature, subsurface temperature, freezing temperature, water film height, friction, saline concentration, road condition, precipitation type, visibility, wind speed, wind direction, air temperature, dewpoint, relative humidity, relative air pressure.

3. The system of claim 1, wherein the at least one sensor includes a weather sensor mountable at road level.

4. The system of claim 1, wherein the at least one sensor includes a weather sensor mountable above road level.

5. The system of claim 1, wherein the at least one sensor includes a camera.

6. The system of claim 1, wherein the interface card includes programmed functionality to communicate with the weather station and the remote computing device using a protocol selected from Ethernet, USB, WiFi and Cellular.

7. The system of claim 1, wherein the signaling from the weather station uses RS-485.

8. The system of claim 1, wherein the card is adapted for insertion in the detection rack by having a form factor approximating the form factor of a traffic detection card.

9. The system of claim 1, wherein the sensors use power and/or communications connections or wiring preexisting in the traffic cabinet.

10. A weather data processing system, comprising:
a plurality of weather stations each having at least one sensor;
a plurality of interface cards, each integrated with a traffic cabinet co-located at intersection level with a respective one of the plurality of weather stations, each interface card having embedded firmware to receive data from the respective weather station;
a centralized hub for receiving data from the plurality of interface cards and processing the data to provide localized weather reporting and forecasting.

11. The weather data processing system of claim 10, wherein at least one of the weather stations is mounted on a power pole, utility pole, or traffic signal pole preexisting at the intersection.

12. The weather data processing system of claim 10, wherein the weather data is preprocessed before transmitting the data to the centralized hub.

13. The weather data processing system of claim 10, wherein the weather data is processed before being transmitted by the centralized hub for reporting and forecasting.

14. The weather data processing system of claim 10, wherein the localized weather reporting and forecasting is directed to a user device.

15. The weather data processing system of claim 10, wherein the localized weather reporting and forecasting is directed to a mobile or onboard device.

16. The weather data processing system of claim 10, wherein the localized weather reporting and forecasting is directed to a subscriber near the intersection.

17. The weather data processing system of claim 10, wherein the localized weather reporting and forecasting is directed to a connected vehicle or autonomous vehicle (CAV) near the intersection.

18. The weather data processing system of claim 10, wherein an alert related to the localized weather reporting and forecasting is directed to a road display.

19. The weather data processing system of claim 10, wherein the at least one sensor of each of the weather stations uses power and/or communications connections or wiring preexisting in the respective traffic cabinets.

20. A method for retrieving localized weather data, comprising:
retrieving from a weather station having at least one sensor disposed at an intersection with a traffic cabinet a string of weather related data;
through an interface card adapted for insertion in a detection rack of the traffic cabinet, the card having embedded firmware to receive data from the at least one sensor of the weather station, communicating the data to at least one remote computing device for processing with data of other weather stations.

21. The method of claim 20, wherein the at least one sensor uses power and/or communications connections or wiring preexisting in the traffic cabinet.
